(19) United States
(12) Patent Application Publication
(10) Pub. No.: US 2025/0070199 A1
(43) Pub. Date: Feb. 27, 2025

(54) FUEL CELL ELECTRIC VEHICLE HAVING RANGE EXTENSION ARCHITECTURE

(71) Applicant: FCA US LLC, Auburn Hills, MI (US)

(72) Inventors: Prashant Khot, Pune (IN); Sushant Bapat, Pune (IN)

(21) Appl. No.: 18/455,771

(22) Filed: Aug. 25, 2023

(51) Int. Cl. H01M 8/04082; B60L 50/75; B60L 58/32; H01M 8/04007

(52) U.S. Cl. CPC H01M 8/04208; B60L 50/75; B60L 58/32; H01M 8/04067; B60L 53/16; H01M 2250/20

(57) ABSTRACT

A fuel cell electric vehicle (FCEV) includes an electric drive motor, a hydrogen fuel cell, an on-board hydrogen storage tank, a portable hydrogen storage cartridge, a controller, a battery pack and a plug interface having a vehicle charging inlet. The electric drive motor delivers drive torque to at least one drive wheel. The on-board hydrogen storage tank is configured to store hydrogen and selectively supply the hydrogen to the fuel cell in a first operating mode. The portable hydrogen storage cartridge selectively connects to a hydrogen portable interface configured on the FCEV. The portable hydrogen storage cartridge supplies the hydrogen to the fuel cell in a second operating mode. The controller determines whether hydrogen from the on-board hydrogen storage tank is supplied to the fuel cell in a first operating mode or hydrogen from the portable hydrogen cartridge is supplied to the fuel cell in the second operating mode.

### FIELD

The present application generally relates to fuel cell electric vehicles and, more particularly, to a fuel cell electric vehicle having a range extension architecture incorporating portable and replaceable hydrogen cartridges.

### BACKGROUND

Conventional gasoline and diesel engines can provide acceptable power output for most vehicles but may have undesirable carbon emissions. Alternative propulsion systems that have less carbon emissions are becoming more popular. For example, an electrified vehicle (hybrid electric, plug-in hybrid electric, range-extended electric, battery electric, etc.) includes at least one battery system and at least one electric motor. Hydrogen fuel cell electric vehicles (FCEV) can also provide an associated powertrain suitable propulsion for most applications.

Generally speaking, alternative propulsion systems that replace gasoline and diesel engines, while offering reduced carbon emissions can suffer from other challenges. For example, FCEV's are fueled by hydrogen. Typically, the hydrogen is stored in on-board hydrogen tanks. Hydrogen can be replenished by refilling the hydrogen tanks at a hydrogen refueling station. In most instances however, hydrogen refueling stations are not yet widespread and are generally less available compared to conventional gasoline and diesel refueling stations. Accordingly, while such vehicle propulsion systems powered by fuel cells work well for their intended purpose, there exists an opportunity for improvement in the relevant art.

### SUMMARY

According to one example aspect of the invention, a fuel cell electric vehicle (FCEV) includes at least one electric drive motor, a hydrogen fuel cell, an on-board hydrogen storage tank, a portable hydrogen storage cartridge and a controller. The at least one electric drive motor delivers drive torque to at least one drive wheel. The hydrogen fuel cell provides an output voltage. The on-board hydrogen storage tank is configured to store hydrogen and selectively supply the hydrogen to the fuel cell in a first operating mode. The portable hydrogen storage cartridge selectively connects to a hydrogen portable interface configured on the FCEV. The portable hydrogen storage cartridge is configured to supply the hydrogen to the fuel cell in a second operating mode. The controller determines whether hydrogen from the on-board hydrogen storage tank is supplied to the fuel cell in a first operating mode or hydrogen from the portable hydrogen cartridge is supplied to the fuel cell in the second operating mode.

In some implementations, the portable hydrogen cartridge includes a tank and a user engagement body having a handle. The FCEV further includes a portable hydrogen storage cartridge door. The portable hydrogen storage cartridge is selectively inserted through the portable hydrogen storage cartridge door.

In some implementations, the portable hydrogen storage cartridge positively locates with the hydrogen portable interface whereby hydrogen is delivered from the portable hydrogen storage cartridge to the fuel cell.

According to another example aspect of the invention, the FCEV includes a battery pack that selectively powers the at least one drive motor. The FCEV further comprising a plug interface having a vehicle charging inlet configured to receive an alternating current (A/C) charge power cable assembly that charges the battery pack.

In some implementations, the controller receives vehicle inputs and determines whether hydrogen is sourced to the fuel cell by the on-board hydrogen storage tank or the portable hydrogen storage cartridge based on operating conditions.

In some implementations, the portable hydrogen storage cartridge further includes a high-density polymer liner and a carbon fiber composite outer member. The portable hydrogen storage cartridge further includes a valve assembly including a valve, and a valve boss. The portable hydrogen storage cartridge further includes a thermal pressure relief device and a temperature sensor. The portable hydrogen storage cartridge removable and replaceable relative to the hydrogen portable interface.

According to another example aspect of the invention, a fuel cell electric vehicle (FCEV) includes at least one electric drive motor, a hydrogen fuel cell, an on-board hydrogen storage tank, and a replaceable hydrogen storage cartridge. The at least one electric drive motor delivers drive torque to at least one drive wheel. The hydrogen fuel cell provides an output voltage. The on-board hydrogen storage tank is configured to store hydrogen and selectively supply the hydrogen to the fuel cell in a first operating mode. The replaceable hydrogen storage cartridge includes a user engagement body having a handle formed thereon. The replaceable hydrogen storage cartridge selectively connects to a hydrogen portable interface configured on the FCEV. The portable hydrogen storage cartridge is configured to supply the hydrogen to the fuel cell in a second operating mode.

In other implementations, the FCEV includes a controller that determines whether hydrogen from the on-board hydrogen storage tank is supplied to the fuel cell in a first operating mode or hydrogen from the portable hydrogen cartridge is supplied to the fuel cell in the second operating mode.

The FCEV further includes a portable hydrogen storage cartridge door. The replaceable hydrogen storage cartridge is selectively inserted through the portable hydrogen storage cartridge door.

In some implementations, the replaceable hydrogen storage cartridge positively locates with the hydrogen portable interface whereby hydrogen is delivered from the replaceable hydrogen storage cartridge to the fuel cell.

According to another example aspect of the invention, the FCEV includes a battery pack that selectively powers the at least one drive motor. The FCEV further comprising a plug interface having a vehicle charging inlet configured to receive an alternating current (A/C) charge power cable assembly that charges the battery pack.

In some implementations, the controller receives vehicle inputs and determines whether hydrogen is sourced to the fuel cell by the on-board hydrogen storage tank or the replaceable hydrogen storage cartridge based on operating conditions.

In some implementations, the replaceable hydrogen storage cartridge further includes a high-density polymer liner and a carbon fiber composite outer member. The replaceable hydrogen storage cartridge further includes a valve assembly including a valve, and a valve boss. The replaceable hydrogen storage cartridge further includes a thermal pressure relief device and a temperature sensor. The replaceable hydrogen storage cartridge removable and replaceable relative to the hydrogen portable interface.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a fuel cell electric vehicle (FCEV) that incorporates on-board hydrogen fuel storage, portable hydrogen fuel storage and a plug in battery charging interface according to the principles of the present application;

FIG. 2 is a partial sectional view of an exemplary portable hydrogen storage tank according to examples of the present disclosure;

FIG. 3 is a perspective view of a portable hydrogen storage tank having a handle according to examples of the present disclosure; and

FIG. 4 is a perspective view of the FCEV shown with three forms of refueling/charging including a portable hydrogen fuel storage tank of FIG. 3 being replaced, the battery being recharged at a battery external charging system and a hydrogen fuel door for refueling the on-board hydrogen storage tank(s) of the FCEV.

### DESCRIPTION

As discussed above, hydrogen fueling stations for FCEV's are very limited making it difficult for travel within (or between) many countries where a planned destination exceeds a range of on-board hydrogen fuel supply. The present disclosure provides a hydrogen portable interface on the FCEV that selectively receives a portable hydrogen storage cartridge or tank. The use of portable hydrogen cartridges allows for simple refueling of the FCEV. The cartridges would contain compressed hydrogen gas, which can be quickly and easily swapped out at a hydrogen refueling station. In the example described herein, the FCEV will have three methods of refueling/recharging. The FCEV can be “refueled” by filling on-board hydrogen storage tank(s) on the FCEV at a hydrogen refueling station. In addition, the FCEV can swap out a hydrogen portable storage cartridge on the FCEV. In another method, a user can connect an A/C charge power cable assembly from an external charging system (at a battery electric vehicle charging station) to a vehicle charging inlet provided on the FCEV. The external charging system can charge a battery pack in the FCEV just as a battery electric vehicle would be charged.

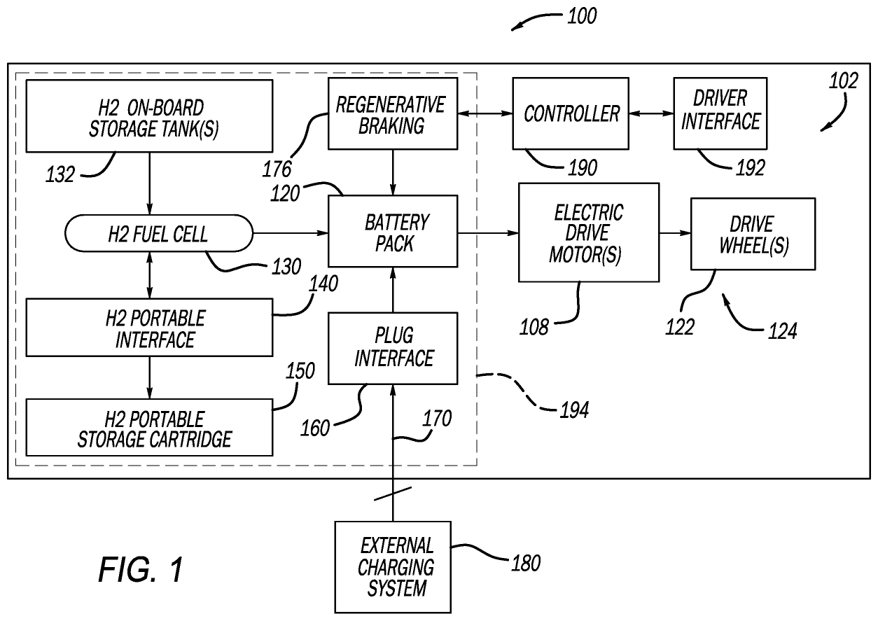

With initial reference to FIG. 1, a FCEV constructed in accordance to one example of the present disclosure is shown and generally identified at reference 100. The FCEV 100 generally includes an electrified powertrain 102 comprising one or more electric motors 108. The electric motor(s) 108 are powered by a high voltage battery pack 120 (e.g., a 16 kilowatt-hour (kWh) lithium-ion battery pack) and a hydrogen fuel cell 130. The electric motor(s) 108 generate drive torque that is transferred to drive wheels 122 provided on a driveline 124 of the FCEV 100.

The hydrogen fuel cell 130 is used to refer to a fuel cell stack having hundreds of fuel cells configured to generate electricity in the form of direct current from electrochemical reactions in the fuel cells. The electricity generated by the hydrogen fuel cell 130 is used to power the electric motor(s) 108 and can be delivered to the battery pack 120 for recharging the battery pack 120. The fuel cell 130 provides an output voltage and is fueled by hydrogen from one or more on-board hydrogen storage tank(s) 132. In examples, the on-board hydrogen storage tank 132 can be a common hydrogen storage tank (or tanks) that fuels the fuel cell 120 as demand dictates.

The FCEV 100 according to the present disclosure incorporates a hydrogen portable interface 140 that selectively receives a portable and replaceable hydrogen storage cartridge or tank 150. The use of portable hydrogen cartridges 150 allows for simple refueling of the FCEV 100. The cartridges 150 would contain compressed hydrogen gas, which can be quickly and easily swapped out at a hydrogen refueling station.

One advantage of portable hydrogen cartridges 150 is the potential to overcome the challenge of building a hydrogen refueling infrastructure which is currently limited. The use of portable hydrogen cartridges 150 could allow for the creation of more distributed refueling network where refueling stations could be located in more convenient locations, such as, but not limited to, parking lots or gas stations. It is also contemplated that in some examples, a vehicle operator may take more than one hydrogen cartridge 150 and keep them in the vehicle (e.g., such as in the trunk, etc.) where they are ready for swapping out of an exhausted hydrogen cartridge as needed.

The FCEV 100 further incorporates a plug interface 160 that can include a vehicle charging inlet 162. An A/C charge power cable assembly 170 can be selectively coupled to the vehicle charging inlet 162. An external charging system 180 can provide power through the A/C charge power cable assembly 170 to the plug interface 160 for charging the battery pack 120. The FCEV 100 will also include a refueling door or connection (see hydrogen refueling door 328, FIG. 4), for replenishing the hydrogen into the on-board storage tank(s) 132 in a similar way to traditional gasoline-powered vehicles.

The FCEV 100 includes a regenerative braking system 176. The regenerative braking system 176 captures energy generated during braking and routes the energy into the battery pack 120 to help recharge the battery pack 120 and extend the electric driving range of the FCEV 100.

In examples, a controller 190 communicates with the battery pack 120, the fuel cell 130, the on-board storage tank 132, the portable interface 140, the hydrogen portable storage cartridge 150, the plug interface 160 and the regenerative braking 176 on a communications bus 194. The controller 190 can determine whether to use the on-board storage tanks 132 or a portable hydrogen cartridge 150 to supply hydrogen to the fuel cell 130 according to driver preferences set and communicated at a driver interface 192. The driver interface 192 can be a vehicle infotainment system, instrument cluster or other suitable driver interface (including a mobile device) that communicates and resets driver preferences.

It is contemplated that in examples, the controller 190 can be configured to first exhaust all hydrogen from the on-board storage tanks 132 prior to using the hydrogen from the portable hydrogen storage cartridge 150. In other examples, the controller 190 can be configured to first exhaust the hydrogen from the portable hydrogen storage cartridge 150 prior to sourcing the hydrogen from the on-board hydrogen storage tanks 132. The driver can set various preferences including hydrogen fueling strategy using the driver interface 192. The driver interface 192 can also display hydrogen storage levels of the hydrogen on-board storage tank(s) 132 and the installed hydrogen portable storage cartridge 150. The driver interface 192 can also display power levels of the battery pack 120. In other examples, the controller 190 can receive vehicle operating conditions and determine whether the hydrogen is sourced by the on-board storage tanks 132 or the portable hydrogen storage cartridge 150. Vehicle operating conditions can include vehicle terrain, proximity to hydrogen refueling stations, and/or status of any of the components on the communication bus 194.

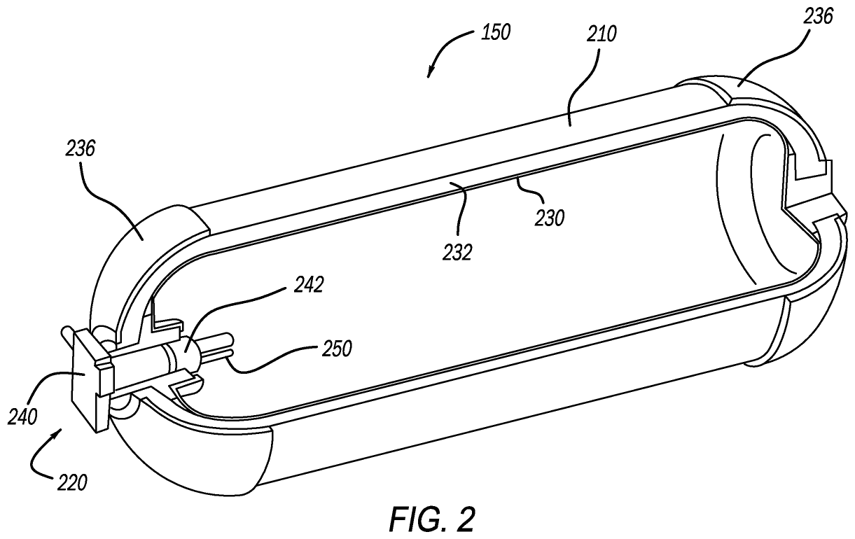

With reference now to FIG. 2, an exemplary hydrogen portable storage cartridge 150 is shown. The hydrogen portable storage cartridge 150 can generally include a tank or body 210 and a valve assembly 220. The tank 210 can include a high-density polymer liner 230, and a carbon fiber composite outer member 232. A dome protection layer 236 can be incorporated at the front and rear portions of the body 210. The valve assembly 220 can further include a valve 240, a valve boss 242, a thermal pressure relief device (TPRD) 248 and a temperature sensor 250. Other configurations are contemplated.

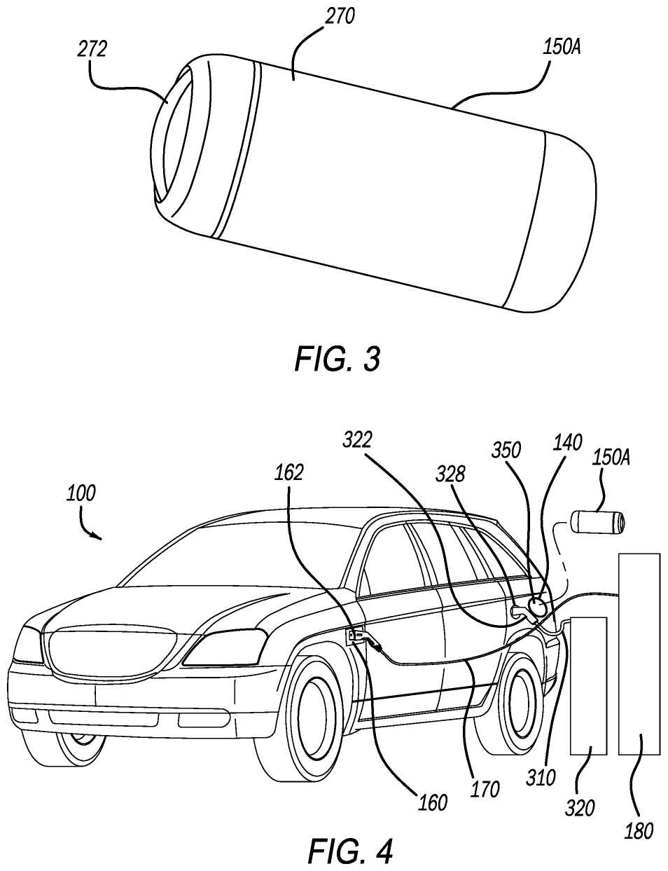

With further reference now to FIGS. 3 and 4, an exemplary method of replacing a hydrogen portable storage cartridge 150A will be described. The hydrogen portable storage cartridge 150A is constructed similarly to the hydrogen portable storage cartridge 150 described above but further incorporates an outer user engagement body 270 that includes a handle 272.

As shown in FIG. 4, the user can refuel/recharge the FCEV 100 using three different methods. In one method, a user can connect an A/C charge power cable assembly 170 from an external charging system 180 to the vehicle charging inlet 162. The external charging system 180 can charge the battery pack 120 just as a battery electric vehicle would be charged.

In a second method, a user can connect a hydrogen fuel supply hose 310 provided from a hydrogen fueling source 320. In examples, a hydrogen fuel nozzle 322 from the fuel supply hose 310 can be inserted into the hydrogen fuel supply door 328 provided on the FCEV 100. Hydrogen, from the hydrogen fueling source 320, can be filled into the hydrogen on-board storage tank(s) 132. Hydrogen, from the on-board storage tank(s) 132 can be supplied to the fuel cell 130 in a first operating mode as determined by the controller 190.

In a third method, a user can swap out an exhausted portable hydrogen storage cartridge 150A for a new (full or otherwise unexhausted) portable storage cartridge 150A. In examples, the FCEV 100 includes a portable hydrogen storage cartridge door 350 where a user can withdrawal and insert the cartridges 150A such as by grasping the handle 272. Once the portable hydrogen storage cartridge 150A is sufficiently inserted into the FCEV 100 at the door 350, it will positively locate with the hydrogen portable interface 140 whereby hydrogen can safely be delivered from the portable hydrogen storage cartridge 150A to the fuel cell 130 in a second operating mode as needed.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A fuel cell electric vehicle (FCEV) comprising:
at least one electric drive motor that delivers drive torque to at least one drive wheel;
a hydrogen fuel cell that provides an output voltage;
an on-board hydrogen storage tank configured to store hydrogen and selectively supply the stored hydrogen to the fuel cell in a first operating mode;
a portable hydrogen storage cartridge that selectively connects to a hydrogen portable interface configured on the FCEV, the portable hydrogen storage cartridge configured to supply the hydrogen to the fuel cell in a second operating mode; and
a controller that determines whether hydrogen from the on-board hydrogen storage tank is supplied to the fuel cell in the first operating mode or hydrogen from the portable hydrogen storage cartridge is supplied to the fuel cell in the second operating mode.

2. The FCEV of claim 1, wherein the portable hydrogen storage cartridge includes a tank and a user engagement body having a handle.

3. The FCEV of claim 2, further comprising:
a portable hydrogen storage cartridge door, wherein the portable hydrogen storage cartridge is selectively inserted through the portable hydrogen storage cartridge door.

4. The FCEV of claim 1, wherein the portable hydrogen storage cartridge positively locates with the hydrogen portable interface whereby hydrogen is delivered from the portable hydrogen storage cartridge to the fuel cell.

5. The FCEV of claim 1, further comprising:
a battery pack that selectively powers the at least one drive motor; and
a plug interface having a vehicle charging inlet configured to receive an alternating current (A/C) charge power cable assembly that charges the battery pack.

6. The FCEV of claim 5, wherein the controller receives vehicle inputs and determines whether hydrogen is sourced to the fuel cell by the on-board hydrogen storage tank or the portable hydrogen storage cartridge based on operating conditions.

7. The FCEV of claim 2, wherein the portable hydrogen storage cartridge further includes a high-density polymer liner and a carbon fiber composite outer member.

8. The FCEV of claim 7, wherein the portable hydrogen storage cartridge further includes a valve assembly including a valve, and a valve boss.

9. The FCEV of claim 9, wherein the portable hydrogen storage cartridge further includes a thermal pressure relief device and a temperature sensor.

10. The FCEV of claim 1, wherein the portable hydrogen storage cartridge removable and replaceable relative to the hydrogen portable interface.

11. A fuel cell electric vehicle (FCEV) comprising:
at least one electric drive motor that delivers drive torque to at least one drive wheel;
a hydrogen fuel cell that provides an output voltage;
an on-board hydrogen storage tank configured to store hydrogen and selectively supply the stored hydrogen to the fuel cell in a first operating mode; and
a replaceable hydrogen storage cartridge having a user engagement body and handle formed thereon, wherein the replaceable hydrogen storage cartridge selectively connects to a hydrogen portable interface configured on the FCEV, the replaceable hydrogen storage cartridge configured to supply the hydrogen to the fuel cell in a second operating mode, the replaceable hydrogen storage cartridge.

12. The FCEV of claim 11, further comprising:
a controller that determines whether hydrogen from the on-board hydrogen storage tank is supplied to the fuel cell in the first operating mode or hydrogen from the portable hydrogen storage cartridge is supplied to the fuel cell in the second operating mode.

13. The FCEV of claim 12, further comprising:
a portable hydrogen storage cartridge door, wherein the replaceable hydrogen storage cartridge is selectively inserted through the portable hydrogen storage cartridge door.

14. The FCEV of claim 11, wherein the portable replaceable storage cartridge positively locates with the hydrogen portable interface whereby hydrogen is delivered from the replaceable hydrogen storage cartridge to the fuel cell.

15. The FCEV of claim 11, further comprising:
a battery pack that selectively powers the at least one drive motor; and
a plug interface having a vehicle charging inlet configured to receive an alternating current A/C charge power cable assembly that charges the battery pack.

16. The FCEV of claim 15, wherein the controller receives vehicle inputs and determines whether hydrogen is sourced to the fuel cell by the on-board hydrogen storage tank or the replaceable hydrogen storage cartridge based on operating conditions.

17. The FCEV of claim 11, wherein the replaceable hydrogen storage cartridge further includes a high-density polymer liner and a carbon fiber composite outer member.

18. The FCEV of claim 17, wherein the replaceable hydrogen storage cartridge further includes a valve assembly including a valve, and a valve boss.

19. The FCEV of claim 18, wherein the replaceable hydrogen storage cartridge further includes a thermal pressure relief device and a temperature sensor.
